(19) United States
(12) Patent Application Publication
(10) Pub. No.: US 2022/0318338 A1
(43) Pub. Date: Oct. 6, 2022

(54) SECURE CONJUGATE GRADIENT METHOD COMPUTATION SYSTEM, SECURE COMPUTATION APPARATUS, CONJUGATE GRADIENT METHOD COMPUTATION APPARATUS, SECURE CONJUGATE GRADIENT METHOD COMPUTATION METHOD, CONJUGATE GRADIENT METHOD COMPUTATION METHOD, AND PROGRAM

(71) Applicant: NIPPON TELEGRAPH AND TELEPHONE CORPORATION, Tokyo (JP)

(72) Inventor: Koki HAMADA, Musashino-shi, Tokyo (JP)

(73) Assignee: NIPPON TELEGRAPH AND TELEPHONE CORPORATION, Tokyo (JP)

(21) Appl. No.: 17/616,192

(22) PCT Filed: Jun. 7, 2019
(86) PCT No.: PCT/JP2019/022701

§ 371 Date: Dec. 3, 2021

(51) Int. Cl. G06F 17/12; G06F 17/16

(52) U.S. Cl. CPC G06F 17/12; G06F 17/16

(57) ABSTRACT

An initialization unit generates secret values of vectors p\vec{ }₀ and r\vec{ }₀ and a value ρ₀. A first computation unit generates a secret value of a D-fold value of a vector a\vec{ }ᵢ₋₁. A second computation unit generates a secret value of a D-fold value of a value γᵢ₋₁. A third computation unit generates a secret value of a value αᵢ₋₁. A fourth computation unit generates a secret value of a D-fold value of a vector d\vec{ }ᵢ. A fifth computation unit generates a secret value of a vector x\vec{ }ᵢ. A sixth computation unit the generates a secret value of a vector r\vec{ }ᵢ. A seventh computation unit generates a secret value of a D-fold value of a value ρᵢ. An eighth computation unit generates a secret value of a value βᵢ. A ninth computation unit generates a secret value of a vector p\vec{ }ᵢ.

### TECHNICAL FIELD

The invention relates to a numerical computation technique, and particularly relates to a method for efficiently solving simultaneous linear equations using secure computation.

### BACKGROUND ART

A method called a conjugate gradient method is known as an algorithm for solving simultaneous linear equations having a symmetric positive definite matrix as a coefficient. In the conjugate gradient method, iterative computation is used to compute an approximate value of the solution of simultaneous equations (see, for example, NPL 1).

Typically, the conjugate gradient method uses a floating-point number for computation. Also when the conjugate gradient method is used in secure computation, the computation is possible by using a floating-point number. However, in secure computation, the computational cost for a floating-point number is high, and thus the computational cost for the conjugate gradient method with secure computation using a floating-point number is significantly high.

Some of methods in which real numbers are used in secure computation use a fixed-point number, instead of a floating-point number. Because the computational cost for a fixed-point number is lower than the computational cost for a floating-point number, if the conjugate gradient method can be realized by using a fixed-point number, it is possible to reduce the computational cost for the conjugate gradient method.

### CITATION LIST

### Non Patent Literature

[NPL 1] Jonathan Richard Shewchuk, “An Introduction to the Conjugate Gradient Method Without the Agonizing Pain,” 1994.

### SUMMARY OF THE INVENTION

### Technical Problem

However, if the conjugate gradient method is realized by using a fixed-point number, an overflow may occur with a value halfway through computation. If an overflow occurs, a correct computation result cannot be obtained, and thus it is desirable to make it possible to compute the conjugate gradient method so that no overflow occurs.

In view of the foregoing technical problem, an object of the present invention is to reduce the probability that an overflow will occur when the conjugate gradient method is realized by using a fixed-point number.

### Means for Solving the Problem

In order to solve the foregoing problem, a secure conjugate gradient method computation system according to an aspect of the present invention includes a plurality of secure computation apparatuses, the secure conjugate gradient method computation system being configured to obtain, letting X be a set of values for computing a product of a d-dimensional real symmetric positive definite matrix A and a d-dimensional vector, b\vec{ } be a d-dimensional vector, f be a function for computing Ax\vec{ } based on a matrix X and a d-dimensional vector x\vec{ }, k be an integer of d or less, i be each of integers from 1 to k, x\vec{ }₀ be a d-dimensional vector for which a suitable value is set, and D be a value whose absolute value is less than 1 and other than 0, an approximate solution x\vec{ }ₖ of a solution x\vec{ }* of Ax\vec{ }=b\vec{ } with secret values of the set X and a secret value of the vector b\vec{ } used as inputs.

Each of the secure computation apparatuses includes: an initialization unit, a first computation unit, a second computation unit, a third computation unit, a fourth computation unit, a fifth computation unit, a sixth computation unit, a seventh computation unit, an eighth computation unit, and a ninth computation unit.

The initialization unit is configured to compute the following expression using secure computation, and generate secret values of vectors p\vec{ }₀ and r\vec{ }₀ and a value ρ₀;

\vec{p}₀=\vec{r}₀=\vec{b}−ƒ(X,\vec{x}₀), ρ₀=\vec{r}₀^{T}\vec{r}₀ [Math. 1]

The first computation unit is configured to compute the following expression using secure computation, and generate a secret value of a vector a\vec{ }ᵢ₋₁;

\vec{a}ᵢ₋₁=D×(ƒ(X,\vec{p}ᵢ₋₁)) [Math. 2]

The second computation unit is configured to compute the following expression using secure computation, and generate a secret value of a value γᵢ₋₁;

γᵢ₋₁=D×(\vec{p}ᵢ₋₁^{T}\vec{a}ᵢ₋₁) [Math. 3]

The third computation unit is configured to compute the following expression using secure computation, and generate a secret value of a value αᵢ₋₁;

$${α}_{i - 1} = \frac{{ρ}_{i - 1}}{{γ}_{i - 1}} \qquad [ Math . 4 ]$$

The fourth computation unit is configured to compute the following expression using secure computation, and generate a secret value of a vector d\vec{ }ᵢ;

\vec{d}ᵢ=D×(αᵢ₋₁\vec{p}ᵢ₋₁) [Math. 5]

The fifth computation unit is configured to compute the following expression using secure computation, and generate a secret value of a vector x\vec{ }ᵢ;

\vec{x}ᵢ=\vec{x}ᵢ₋₁+\vec{d}ᵢ [Math. 6]

The sixth computation unit is configured to compute the following expression using secure computation, and generate a secret value of a vector r\vec{ }ᵢ;

\vec{r}ᵢ=\vec{r}ᵢ₋₁−αᵢ₋₁\vec{a}ᵢ₋₁ [Math. 7]

The seventh computation unit is configured to compute the following expression using secure computation, and generate a secret value of a value ρᵢ;

ρᵢ=D×(\vec{r}ᵢ^{T}\vec{r}ᵢ) [Math. 8]

The eighth computation unit is configured to compute the following expression using secure computation, and generate a secret value of a value βᵢ;

$${β}_{i} = \frac{{ρ}_{i}}{{ρ}_{i - 1}} \qquad [ Math . 9 ]$$

The ninth computation unit is configured to compute the following expression using secure computation, and generate a secret value of a vector p\vec{ }ᵢ.

\vec{p}ᵢ=\vec{r}ᵢ−βᵢ\vec{p}ᵢ₋₁ [Math. 10]

### Effects of the Invention

According to the present invention, values obtained halfway through the computation of the conjugate gradient method can be kept small, thus making it possible to reduce the possibility that an overflow will occur when the conjugate gradient method is realized by using a fixed-point number.

### BRIEF DESCRIPTION OF DRAWINGS

FIG. 1 is a diagram illustrating an example of a functional configuration of a secure conjugate gradient method computation system.

FIG. 2 is a diagram illustrating an example of a functional configuration of a secure computation apparatus.

FIG. 3 is a diagram illustrating an example of a processing procedure of a secure conjugate gradient method computation method.

FIG. 4 is a diagram illustrating an example of a functional configuration of a computer.

### DESCRIPTION OF EMBODIMENTS

First, a notation system and definition of terms in the present specification will be described.

<Notation System>

A symbol “\vec{ }” (superscript arrow) used in the specification is a symbol that should be essentially given immediately above the character immediately before the symbol, but is given immediately after this character due to limitation of text description. In the mathematical expressions, these symbols are given at an original position, that is, at a position immediately above the corresponding character. For example, “a\vec{ }” is expressed, in the mathematical expressions, as follows.

\vec{a} [Math. 11]

For example, as “a\vec{ }”, a symbol with a superscript arrow added immediately after a character (symbol with an arrow added immediately above a character in a mathematical expression) denotes a column vector.

“^{.T}” (superscript index “T”) denotes transposition.

a\vec{ }^{T}b\vec{ } denotes an inner product of a vector a\vec{ } and a vector b\vec{ }.

<Secure Computation>

As a method for obtaining a specific computation result without recovering an encrypted numeric value, there is a method called secure computation (see, for example, Reference Literature 1). In the method described in Reference Literature 1, encryption is performed such that fragments of a numerical value are distributed over three secure computation apparatuses, and the three secure computation apparatuses perform cooperative computation. Accordingly, the three secure computation apparatuses can store a result of addition/subtraction, constant addition, multiplication, constant multiplication, logical operation (NOT, AND, OR, and exclusive-OR), or data format conversion (integer, binary number), without recovering the numerical value, in a state in which it is distributed over the three secure computation apparatuses, that is, in an encrypted state.

[Reference Literature 1] Koji SENDA, Hiroki HAMADA, Masaru IGARASHI, Katsumi TAKAHASHI, “A Three-Party Secure Function Evaluation with Lightweight Verifiability Revisited”, CSS, 2010

<Conjugate Gradient Method>

The conventional conjugate gradient method described in NPL 1 will be described in more detail. The conjugate gradient method is a method for computing, using iterative computation, an approximate value of the solution x\vec{ }*=A⁻¹b\vec{ } of Ax\vec{ }=b\vec{ } with a set X of values for computing a product of a d-dimensional real symmetric positive definite matrix A and a d-dimensional vector, and a d-dimensional vector b\vec{ } used as inputs. Specifically, in the conjugate gradient method, a vector x\vec{ }₀, which is a default approximate solution, is set to a suitable value, the following values are computed in the order from i=1, and a vector x\vec{ }ₖ for sufficiently large k is output as an approximate solution. Note that k is assumed to be up to about d, and is set according to a desired accuracy of approximation. For example, if d=100 is satisfied, it is sufficient to set k=10, for example. Also, the computation of the values does not need to be performed in the order described in the following expression, and may be performed in different order as long as the computation is possible. Alternatively, a plurality of values may also be computed in parallel.

$$\text{?} = \text{?} = \text{?} - f ( X , \text{?} ) \\ {ρ}_{0} = \text{?} \text{?} \\ \text{?} = f ( X , \text{?} ) \\ {γ}_{i - 1} = \text{?} \text{?} \\ {α}_{i - 1} = \frac{{ρ}_{i - 1}}{{γ}_{i - 1}} \\ \text{?} = {α}_{i - 1} \text{?} \\ \text{?} = \text{?} + \text{?} \\ \text{?} = {r}_{i - 1} - {α}_{i - 1} \text{?} \\ {ρ}_{i} = \text{?} \text{?} \\ {β}_{i} = \frac{{ρ}_{i}}{{ρ}_{i - 1}} \\ \text{?} = \text{?} {β}_{i} \text{?} \qquad [ Math . 12 ]$$

$$\text{?} \text{indicates text missing or illegible when filed}$$

Where f is a function for computing Ax\vec{ } based on the set X and a d-dimensional vector x\vec{ }. Specific examples of the set X and the function f are given as follows. Note however that n is a suitable natural number.
X={A}, f(X, x\vec{ })=Ax\vec{ }
X={B}, f(X, x\vec{ })=BB^{T}x\vec{ }, where B is a matrix of d rows and n columns,
X={B, C}, f(X, x\vec{ })=BCB^{T}x\vec{ }, where B is a matrix of d rows and n columns, and C has a diagonal component that is a positive d-order diagonal matrix.

When the conjugate gradient method is performed with secure computation, the conjugate gradient method needs only to define input and output values as secret values by predetermined secret sharing, and realize the computation of the values by, for example, a combination of operations of the secure computation described in Reference Literature 1. That is to say, in the conjugate gradient method, secret values of the set X and the vector b\vec{ } that are subjected to secret sharing are used as inputs, and these values are computed by secure computation in a state in which the original values are kept as secret, and a secret value that serves as an approximate solution x\vec{ }ₖ when being recovered is output.

<Point of The Invention>

The present invention is such that a suitable value D that satisfies |D|<1 and D≠0 (in other words, a suitable value D whose absolute value is less than 1 and other than 0) is set, and when values of a\vec{ }ᵢ₋₁, γᵢ₋₁, d\vec{ }ᵢ, and ρᵢ are computed in the conjugate gradient method, D-fold values of these values are computed, and are defined as the respective values of a\vec{ }ᵢ₋₁, γᵢ₋₁, d\vec{ }ᵢ, and ρᵢ. Accordingly, values that are obtained halfway through computation of the conjugate gradient method and are likely to be large values can be kept small, thus making it possible to reduce the probability that an overflow will occur. The point of the present invention is a configuration in which, particularly, the magnitudes of values obtained halfway through the computation are changed but the finally obtained solution is not changed.

Hereinafter, an embodiment of the present invention will be described in detail. Note that, in the drawings, the same reference numerals are given to the same constituent components, and redundant descriptions are omitted.

### Embodiment

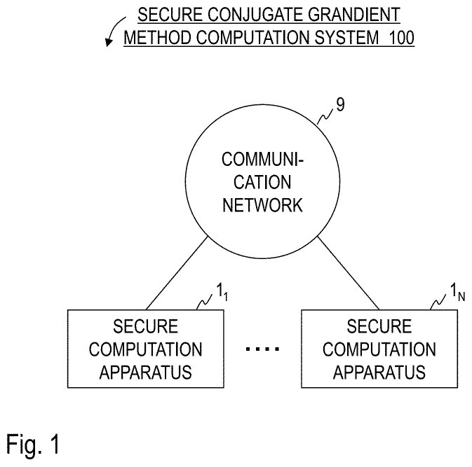

An example of a configuration of a secure conjugate gradient method computation system according to an embodiment will be described with reference to FIG. 1. As shown in FIG. 1, a secure conjugate gradient method computation system 100 includes, for example, N (≥2) secure computation apparatuses 1₁, . . . , 1_{N}. In the present embodiment, the secure computation apparatuses 1₁, . . . , 1_{N} are each connected to a communication network 9. The communication network 9 is a circuit switching type or packet switching type communication network that is configured so that the connected apparatuses are capable of communicating with each other, and the communication network 9 can be, e.g., the Internet, a LAN (Local Area Network), a WAN (Wide Area Network), or the like. Note that the apparatuses cannot necessarily online communicate with each other via the communication network 9. For example, the secure computation apparatuses may also be configured such that information to be input to the secure computation apparatuses 1₁, . . . , 1_{N} is stored in a portable recording medium such as a magnetic tape and a USB memory, and is input offline from the portable recording medium to the secure computation apparatuses 1₁, . . . , 1_{N}.

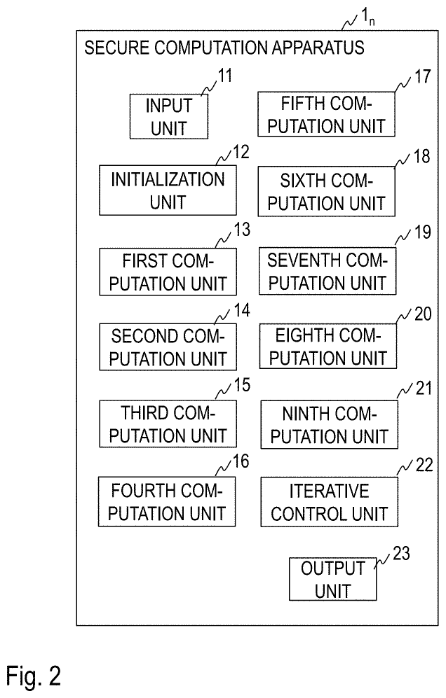

An example of a configuration of a secure computation apparatus 1ₙ (n=1, . . . , N) included in the secure conjugate gradient method computation system 100 according to the embodiment will be described with reference to FIG. 2. As shown in FIG. 2, the secure computation apparatus 1ₙ includes, for example, an input unit 11, an initialization unit 12, a first computation unit 13, a second computation unit 14, a third computation unit 15, a fourth computation unit 16, a fifth computation unit 17, a sixth computation unit 18, a seventh computation unit 19, an eighth computation unit 20, a ninth computation unit 21, an iterative control unit 22, and an output unit 23. As a result of this secure computation apparatus 1ₙ (n=1, . . . , N) cooperating with another secure computation apparatus 1_{n′} (n′=1, . . . , N, where n≠n′) to execute processing of later-described steps, a secure conjugate gradient method computation method according to the present embodiment is realized.

The secure computation apparatus 1ₙ is, for example, a specific apparatus obtained by a well-known or dedicated computer including a Central Processing Unit (CPU), a main storage unit (RAM: Random Access Memory), and the like reading a specific program. The secure computation apparatus 1ₙ executes various types of processing under control of the central processing unit, for example. Data input to the secure computation apparatus 1ₙ and data obtained by each type of processing are stored in, for example, the main storage unit, and the data stored in the main storage unit is read to the central processing unit as needed, and is used for another type of processing. At least some of the processing units of the secure computation apparatus 1ₙ may be constituted by hardware such as an integrated circuit.

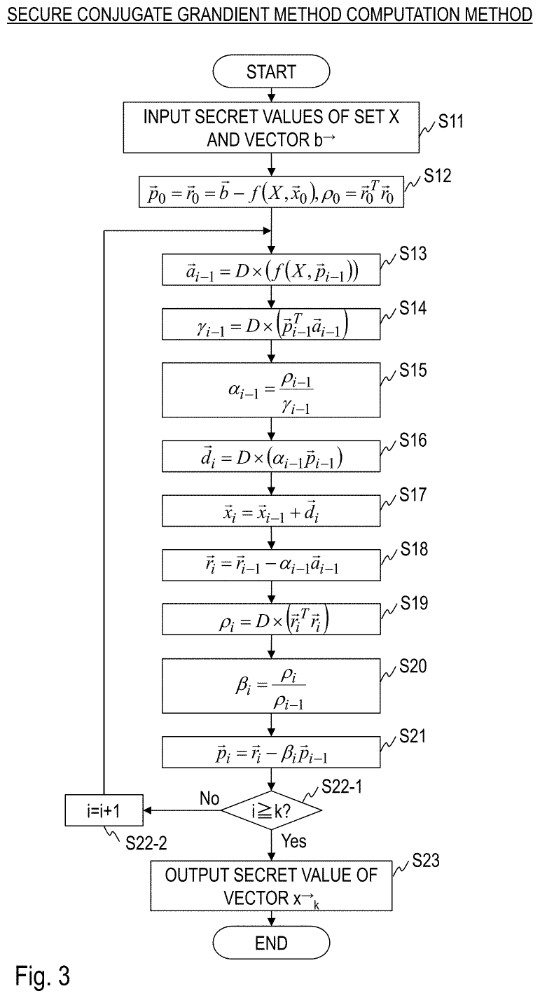

A processing procedure of the secure conjugate gradient method computation method executed by the secure conjugate gradient method computation system 100 according to the embodiment will be described with reference to FIG. 3.

In step S11, secret values of the set X and a secret value of the vector b\vec{ } are input to the input unit 11 of each secure computation apparatus 1ₙ. The set X is a set of values for computing the product of the d-dimensional real symmetric positive definite matrix A and a d-dimensional vector. The vector b\vec{ } is a d-dimensional vector. The input unit 11 outputs the secret values of the set X and the secret value of the vector b\vec{ } to the initialization unit 12.

In step S12, the initialization unit 12 of the secure computation apparatus 1ₙ sets a default approximate solution x\vec{ }₀ to a suitable value (that is, generate a vector x\vec{ }₀ for which a suitable value is set), computes the following expression using secure computation, and generates secret values of vectors p\vec{ }₀ and r\vec{ }₀ and a value ρ₀. Also, the initialization unit 12 initializes the index i of the iterative processing to i=1.

\vec{p}₀=\vec{r}₀=\vec{b}−ƒ(X,\vec{x}₀), ρ₀=\vec{r}₀^{T}\vec{r}₀ [Math. 13]

The initialization unit 12 outputs the secret value of the vector p\vec{ }₀ to the first computation unit 13, the second computation unit 14, the fourth computation unit 16, and the ninth computation unit 21. Also, the initialization unit 12 outputs the secret value of the vector r\vec{ }₀ to the sixth computation unit 18. Furthermore, the initialization unit 12 outputs the secret value of the value ρ₀ to the third computation unit 15 and the eighth computation unit 20. Then, the initialization unit 12 outputs the index i to the iterative control unit 22.

In step S13, the first computation unit 13 of each secure computation apparatus 1ₙ computes the following expression using secure computation, and generates a secret value of a vector a\vec{ }ᵢ₋₁. That is to say, the first computation unit 13 multiplies each value of the vector a\vec{ }ᵢ₋₁ obtained by the conventional conjugate gradient method by D, and defines the obtained product as the value of the vector a\vec{ }ᵢ₋₁. The first computation unit 13 outputs the secret value of the vector a\vec{ }ᵢ₋₁ to the second computation unit 14 and the sixth computation unit 18.

\vec{a}ᵢ₋₁=D×(ƒ(X,\vec{p}ᵢ₋₁)) [Math. 14]

In step S14, the second computation unit 14 of each secure computation apparatus 1ₙ computes the following expression using secure computation, and generates a secret value of a value γᵢ₋₁. That is to say, the second computation unit 14 multiplies the value γᵢ₋₁ obtained by the conventional conjugate gradient method by D, and defines the obtained product as the value γᵢ₋₁. The second computation unit 14 outputs the secret value of the value γᵢ₋₁ to the third computation unit 15.

γᵢ₋₁=D×(\vec{p}ᵢ₋₁^{T}\vec{a}ᵢ₋₁) [Math. 15]

In step S15, the third computation unit 15 of each secure computation apparatus 1ₙ computes the following expression using secure computation, and generates a secret value of a value αᵢ₋₁. The third computation unit 15 outputs the secret value of the value αᵢ₋₁ to the fourth computation unit 16 and the sixth computation unit 18.

$${α}_{i - 1} = \frac{{ρ}_{i - 1}}{{γ}_{i - 1}} \qquad [ Math . 16 ]$$

In step S16, the fourth computation unit 16 of each secure computation apparatus 1ₙ computes the following expression using secure computation, and generates a secret value of a vector d\vec{ }ᵢ. That is to say, the fourth computation unit 16 multiplies each value of the vector d\vec{ }ᵢ obtained by the conventional conjugate gradient method by D, and defines the obtained product as the value of the vector d\vec{ }ᵢ. The fourth computation unit 16 outputs the secret value of the vector d\vec{ }ᵢ to the fifth computation unit 17.

\vec{d}ᵢ=D×(αᵢ₋₁\vec{p}ᵢ₋₁) [Math. 17]

In step S17, the fifth computation unit 17 of each secure computation apparatus 1ₙ computes the following expression using secure computation, and generates a secret value of a vector x\vec{ }ᵢ. The fifth computation unit 17 outputs the secret value of the vector x\vec{ }ᵢ to the output unit 23.

\vec{x}ᵢ=\vec{x}ᵢ₋₁+\vec{d}ᵢ [Math. 18]

In step S18, the sixth computation unit 18 of each secure computation apparatus 1ₙ computes the following expression using secure computation, and generates a secret value of a vector r\vec{ }ᵢ. The sixth computation unit 18 outputs the secret value of the vector r\vec{ }ᵢ to the seventh computation unit 19.

\vec{r}ᵢ=\vec{r}ᵢ₋₁−αᵢ₋₁\vec{a}ᵢ₋₁ [Math. 19]

In step S19, the seventh computation unit 19 of each secure computation apparatus 1ₙ computes the following expression using secure computation, and generates a secret value of a value ρᵢ. That is to say, the seventh computation unit 19 multiplies each value ρᵢ obtained by the conventional conjugate gradient method by D, and defines the obtained product as the value ρᵢ. The seventh computation unit 19 outputs the secret value of the value ρᵢ to the eighth computation unit 20.

ρᵢ=D×(\vec{r}ᵢ^{T}\vec{r}ᵢ) [Math. 20]

In step S20, the eighth computation unit 20 of each secure computation apparatus 1ₙ computes the following expression using secure computation, and generates a secret value of a value βᵢ. The eighth computation unit 20 outputs the secret value of the value βᵢ to the ninth computation unit 21.

$${β}_{i} = \frac{{ρ}_{i}}{{ρ}_{i - 1}} \qquad [ Math . 21 ]$$

In step S21, the ninth computation unit 21 of each secure computation apparatus 1ₙ computes the following expression using secure computation, and generates a secret value of a vector p\vec{ }ᵢ. The ninth computation unit 21 outputs the secret value of the vector p\vec{ }ᵢ to the first computation unit 13, second computation unit 14, and the fourth computation unit 16.

\vec{p}ᵢ=\vec{r}ᵢ−βᵢ\vec{p}ᵢ₋₁ [Math. 22]

In step S22-1, the iterative control unit 22 of each secure computation apparatus 1ₙ determines whether or not i is k or more, that is, whether or not i≥k is satisfied. Note however that k is a predetermined integer that is sufficiently large. If it is determined that i≥k is not satisfied, that is, i<k is satisfied, the iterative control unit 22 moves to the processing in step S22-2. Whereas if it is determined that i≥k is satisfied, the iterative control unit 22 moves to the processing in step S23. In step S22-2, the iterative control unit 22 of the secure computation apparatus 1ₙ increments i by 1, that is, computes i=i+1, and returns to the processing in step S13. In other words, the iterative control unit 22 performs control so that with respect to each i, where i=1, . . . , k, the processing from the first computation unit 13 to the ninth computation unit 21 is repeatedly performed.

In step S23, the output unit 23 of each secure computation apparatus 1ₙ outputs the secret value of the vector x\vec{ }ₖ as a secret value of an approximate value of the solution x\vec{ }*=A⁻¹b\vec{ } of Ax\vec{ }=b\vec{ }.

[Modification]

In the above-described embodiment, a configuration has been described in which the present invention is applied when a conjugate gradient method is realized by secure computation. However, in addition to the case using secure computation, the present invention is also applicable to a case where one computer computes the conjugate gradient method using input and output as plain text. In this case, similar to the secure computation apparatus 1ₙ of the embodiment, a conjugate gradient method computation apparatus according to a modification includes the input unit 11, the initialization unit 12, the first computation unit 13, the second computation unit 14, the third computation unit 15, the fourth computation unit 16, the fifth computation unit 17, the sixth computation unit 18, the seventh computation unit 19, the eighth computation unit 20, the ninth computation unit 21, the iterative control unit 22, and the output unit 23, and is configured to perform computation of the processing units using plain text. That is to say, the conjugate gradient method computation apparatus according to the modification needs only to receive inputs of a set X in plain text and a vector b\vec{ } in plain text, multiply the values of a\vec{ }ᵢ₋₁, γᵢ₋₁, d\vec{ }ᵢ, and ρᵢ obtained by the conventional conjugate gradient method by D, define the obtained products as the values of a\vec{ }ᵢ₋₁, γᵢ₋₁, d\vec{ }ᵢ, and ρᵢ, and output an approximate solution x\vec{ }ₖ in plain text.

<Effects of the Present Invention>

In a conjugate gradient method, the larger the dimension d of a matrix is, the greater a value obtained halfway through computation is. For example, in a case where k×k matrices A are arranged in a matrix, and k vectors b\vec{ } are arranged vertically, values of a\vec{ }ᵢ, γᵢ, αᵢ, d\vec{ }ᵢ, x\vec{ }ᵢ, and ρᵢ are respectively k-fold, k²-fold, k⁻¹-fold, k⁻¹-fold, k⁻¹-fold, and k-fold of the original values before the arrangement, and the values of a\vec{ }ᵢ, γᵢ, and ρᵢ are greater than the original values.

In the configuration of the embodiment, it is possible to multiply ρᵢ by D, a\vec{ }ᵢ by D, γᵢ by D², and αᵢ by 1/D, where D is a suitable value that satisfies both |DS|<1 and D≠0, without changing the value of an approximate solution. Accordingly, in the configuration of the embodiment, it is possible to keep the values of a\vec{ }ᵢ, γᵢ, and ρᵢ small. Here, ρᵢ is an error sum of squares that appears when the conjugate gradient method is computed. Also, a\vec{ }ᵢ is a product of a matrix and a basis vector. Also, γᵢ is a square sum of the basis vector with respect to the matrix. Also, αᵢ is a ratio of the error sum of squares to the basis vector.

According to the present invention, similar to the above-described example, also in a case where, e. g., k×k matrices A are arranged in a matrix and k vectors b\vec{ } are arranged vertically, by setting D=1/k, it is possible to respectively define the values of a\vec{ }ᵢ, γᵢ, αᵢ, d\vec{ }ᵢ, x\vec{ }ᵢ, and ρᵢ as being 1-fold, 1-fold, 1-fold, k⁻¹-fold, k⁻¹-fold, and 1-fold of the original values before the arrangement. Accordingly, it is possible to keep the halfway values smaller than or equal to the original values without changing the value of the solution, and to reduce the probability that an overflow will occur.

The embodiment of the present invention has been described, but the specific configurations are not limited to the embodiment, and possible changes in design and the like are, of course, included in the present invention without departing from the spirit of the present invention is. Various types of processing described in the embodiment may be not only executed in a time series manner in accordance with the order of description, but also executed in parallel or individually when necessary or according to the throughput of the apparatus that performs the corresponding processing.

[Program and Storage Medium]

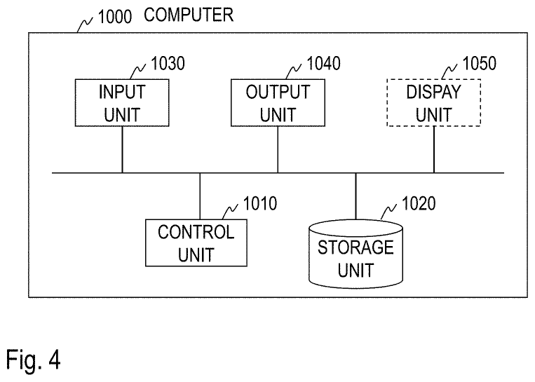

When various types of processing functions of the apparatuses described in the embodiment are implemented by a computer, the processing details of the functions that should be provided by each apparatus are described by a program. When the program is read in a storage unit 1020 of a computer shown in FIG. 4 and is operated by a control unit 1010, an input unit 1030, an output unit 1040, and the like, various types of processing functions of each apparatus are implemented on the computer.

The program in which the processing details is described can be recorded in a computer-readable recording medium. The computer-readable recording medium can be any type of recording medium such as a magnetic recording apparatus, an optical disk, a magneto-optical storage medium, a semiconductor memory, or the like, for example.

Also, this program is distributed by, e. g., selling, transferring, or lending a portable recording medium such as a DVD or a CD-ROM in which this program is recorded, for example. Furthermore, this program may also be distributed by storing the program in a storage device of a server computer, and forwarding the program from the server computer to another computer via a network.

A computer that executes this type of program first stores the program recorded in the portable recording medium or the program transferred from the server computer in its own storage device, for example. Then, when executing processing, this computer reads the program stored in the own storage device and executes processing in accordance with the read program. Also, in another execution mode of this program, the computer may directly read the program from the portable recording medium and may execute the processing in accordance with this program. In yet another execution mode of this program, each time the program is transferred to this computer from the server computer, this computer may execute the processing in accordance with the received program. A configuration is also possible in which the above-described processing is executed by a so-called ASP (Application Service Provider) service, which realizes processing functions only by giving program execution instructions and acquiring the results thereof without transferring the program from the server computer to this computer. Note that it is assumed that the programs of this embodiment include information that is provided for use in processing by an electronic computer and is treated as a program (that is not a direct instruction to the computer but is data or the like having characteristics that specify the processing executed by the computer).

Also, in this embodiment, the apparatuses are configured by executing the predetermined programs on the compute, but at least part of the processing details may also be implemented by hardware.

1. A secure conjugate gradient method computation system comprising a plurality of secure computation apparatuses, the secure conjugate gradient method computation system being configured to obtain, letting X be a set of values for computing a product of a d-dimensional real symmetric positive definite matrix A and a d-dimensional vector, b\vec{ } be a d-dimensional vector, f be a function for computing Ax\vec{ } based on a matrix X and a d-dimensional vector x\vec{ }, k be an integer of d or less, i be each of integers from 1 to k, x\vec{ }₀ be a d-dimensional vector for which a suitable value is set, and D be a value whose absolute value is less than 1 and other than 0, an approximate solution x\vec{ }ₖof a solution x\vec{ }* of Ax\vec{ }=b\vec{ } with secret values of the set X and a secret value of the vector b\vec{ } used as inputs,
wherein each of the secure computation apparatuses includes:
initialization circuitry configured to compute the following expression using secure computation, and generate secret values of vectors p\vec{ }₀ and r\vec{ }₀ and a value ρ₀;
\vec{p}₀=\vec{r}₀=\vec{b}−ƒ(X,\vec{x}₀), ρ₀=\vec{r}₀^{T}\vec{r}₀
first computation circuitry configured to compute the following expression using secure computation, and generate a secret value of a vector a\vec{ }ᵢ₋₁;
\vec{a}ᵢ₋₁=D×(ƒ(X,\vec{p}ᵢ₋₁))
second computation circuitry configured to compute the following expression using secure computation, and generate a secret value of a value γᵢ₋₁;
γᵢ₋₁=D×(\vec{p}ᵢ^{T}\vec{a}ᵢ₋₁)
third computation circuitry configured to compute the following expression using secure computation, and generate a secret value of a value αᵢ₋₁;
$${α}_{i - 1} = \frac{{ρ}_{i - 1}}{{γ}_{i - 1}}$$
fourth computation circuitry configured to compute the following expression using secure computation, and generate a secret value of a vector d\vec{ }ᵢ;
\vec{d}ᵢ=D×(αᵢ₋₁\vec{p}ᵢ₋₁)
fifth computation circuitry configured to compute the following expression using secure computation, and generate a secret value of a vector x\vec{ }ᵢ;
\vec{x}ᵢ=\vec{x}ᵢ₋₁+\vec{d}ᵢ
sixth computation circuitry configured to compute the following expression using secure computation, and generate a secret value of a vector r\vec{ }ᵢ;
\vec{r}ᵢ=\vec{r}ᵢ₋₁−αᵢ₋₁\vec{a}ᵢ₋₁
seventh computation circuitry configured to compute the following expression using secure computation, and generate a secret value of a value ρᵢ;
ρᵢ=D×(\vec{r}ᵢ^{T}\vec{r}ᵢ)
eighth computation circuitry configured to compute the following expression using secure computation, and generate a secret value of a value βᵢ;
$${β}_{i} = \frac{{ρ}_{i}}{{ρ}_{i - 1}}$$
ninth computation circuitry configured to compute the following expression using secure computation, and generate a secret value of a vector p\vec{ }ᵢ.
\vec{p}ᵢ=\vec{r}ᵢ−βᵢ\vec{p}ᵢ₋₁

2. A secure computation apparatus used in a secure conjugate gradient method computation system configured to obtain, letting X be a set of values for computing a product of a d-dimensional real symmetric positive definite matrix A and a d-dimensional vector, b\vec{ } be a d-dimensional vector, f be a function for computing Ax\vec{ } based on a matrix X and a d-dimensional vector x\vec{ }, k be an integer of d or less, i be each of integers from 1 to k, x\vec{ }₀ be a d-dimensional vector for which a suitable value is set, and D be a value whose absolute value is less than 1 and other than 0, an approximate solution x\vec{ }ₖ of a solution x\vec{ }* of Ax\vec{ }=b\vec{ } with secret values of the set X and a secret value of the vector b\vec{ } used as inputs,
the secure computation apparatus comprising:
initialization circuitry configured to compute the following expression using secure computation, and generate secret values of vectors p\vec{ }₀ and r\vec{ }₀ and a value ρ₀;
\vec{p}₀=\vec{r}₀=\vec{b}−ƒ(X,\vec{x}₀), ρ₀=\vec{r}₀^{T}\vec{r}₀
first computation circuitry configured to compute the following expression using secure computation, and generate a secret value of a vector a\vec{ }ᵢ₋₁;
\vec{a}ᵢ₋₁=D×(ƒ(X,\vec{p}ᵢ₋₁))
second computation circuitry configured to compute the following expression using secure computation, and generate a secret value of a value γᵢ₋₁;
γᵢ₋₁=D×(\vec{p}ᵢ^{T}\vec{a}ᵢ₋₁)
third computation circuitry configured to compute the following expression using secure computation, and generate a secret value of a value αᵢ₋₁;
$${α}_{i - 1} = \frac{{ρ}_{i - 1}}{{γ}_{i - 1}}$$
fourth computation circuitry configured to compute the following expression using secure computation, and generate a secret value of a vector d\vec{ }ᵢ;
\vec{d}ᵢ=D×(αᵢ₋₁\vec{p}ᵢ₋₁)
fifth computation circuitry configured to compute the following expression using secure computation, and generate a secret value of a vector x\vec{ }ᵢ;
\vec{x}ᵢ=\vec{x}ᵢ₋₁+\vec{d}ᵢ
sixth computation circuitry configured to compute the following expression using secure computation, and generate a secret value of a vector r\vec{ }ᵢ;
\vec{r}ᵢ=\vec{r}ᵢ₋₁−αᵢ₋₁\vec{a}ᵢ₋₁
seventh computation circuitry configured to compute the following expression using secure computation, and generate a secret value of a value ρᵢ;
ρᵢ=D×(\vec{r}ᵢ^{T}\vec{r}ᵢ)
eighth computation circuitry configured to compute the following expression using secure computation, and generate a secret value of a value βᵢ;
$${β}_{i} = \frac{{ρ}_{i}}{{ρ}_{i - 1}}$$
ninth computation circuitry configured to compute the following expression using secure computation, and generate a secret value of a vector p\vec{ }ᵢ.
\vec{p}ᵢ=\vec{r}ᵢ−βᵢ\vec{p}ᵢ₋₁

3. A conjugate gradient method computation apparatus configured to obtain, letting X be a set of values for computing a product of a d-dimensional real symmetric positive definite matrix A and a d-dimensional vector, b\vec{ } be a d-dimensional vector, f be a function for computing Ax\vec{ } based on a matrix X and a d-dimensional vector x\vec{ }, k be an integer of d or less, i be each of integers from 1 to k, x\vec{ }₀ be a d-dimensional vector for which a suitable value is set, and D be a value whose absolute value is less than 1 and other than 0, an approximate solution x\vec{ }ₖ of a solution x\vec{ }* of Ax\vec{ }=b\vec{ } with the set X and the vector b\vec{ } used as inputs, the conjugate gradient method computation apparatus comprising:
initialization circuitry configured to compute the following expression, and generate vectors p\vec{ }₀ and r\vec{ }₀ and a value ρ₀;
\vec{p}₀=\vec{r}₀=\vec{b}−ƒ(X,\vec{x}₀), ρ₀=\vec{r}₀^{T}\vec{r}₀
first computation circuitry configured to compute the following expression using secure computation, and generate a secret value of a vector a\vec{ }ᵢ₋₁;
\vec{a}ᵢ₋₁=D×(ƒ(X,\vec{p}ᵢ₋₁))
second computation circuitry configured to compute the following expression using secure computation, and generate a secret value of a value γᵢ₋₁;
γᵢ₋₁=D×(\vec{p}ᵢ^{T}\vec{a}ᵢ₋₁)
third computation circuitry configured to compute the following expression using secure computation, and generate a secret value of a value αᵢ₋₁;
$${α}_{i - 1} = \frac{{ρ}_{i - 1}}{{γ}_{i - 1}}$$
fourth computation circuitry configured to compute the following expression using secure computation, and generate a secret value of a vector d\vec{ }ᵢ;
\vec{d}ᵢ=D×(αᵢ₋₁\vec{p}ᵢ₋₁)
fifth computation circuitry configured to compute the following expression using secure computation, and generate a secret value of a vector x\vec{ }ᵢ;
\vec{x}ᵢ=\vec{x}ᵢ₋₁+\vec{d}ᵢ
sixth computation circuitry configured to compute the following expression using secure computation, and generate a secret value of a vector r\vec{ }ᵢ;
\vec{r}ᵢ=\vec{r}ᵢ₋₁−αᵢ₋₁\vec{a}ᵢ₋₁
seventh computation circuitry configured to compute the following expression using secure computation, and generate a secret value of a value ρᵢ;
ρᵢ=D×(\vec{r}ᵢ^{T}\vec{r}ᵢ)
eighth computation circuitry configured to compute the following expression using secure computation, and generate a secret value of a value βᵢ;
$${β}_{i} = \frac{{ρ}_{i}}{{ρ}_{i - 1}}$$
ninth computation circuitry configured to compute the following expression using secure computation, and generate a secret value of a vector p\vec{ }ᵢ.
\vec{p}ᵢ=\vec{r}ᵢ−βᵢ\vec{p}ᵢ₋₁

4. A secure conjugate gradient method computation method executed by a secure conjugate gradient method computation system including a plurality of secure computation apparatuses, the secure conjugate gradient method computation system being configured to obtain, letting X be a set of values for computing a product of a d-dimensional real symmetric positive definite matrix A and a d-dimensional vector, b\vec{ } be a d-dimensional vector, f be a function for computing Ax\vec{ } based on a matrix X and a d-dimensional vector x\vec{ }, k be an integer of d or less, i be each of integers from 1 to k, x\vec{ }₀ be a d-dimensional vector for which a suitable value is set, and D be a value whose absolute value is less than 1 and other than 0, an approximate solution x\vec{ }ₖ of a solution x\vec{ }* of Ax\vec{ }=b\vec{ } with secret values of the set X and a secret value of the vector b\vec{ } used as inputs,
the secure conjugate gradient method computation method comprising:
computing the following expression using secure computation, and generating secret values of vectors p\vec{ }₀ and r\vec{ }₀ and a value ρ₀;
\vec{p}₀=\vec{r}₀=\vec{b}−ƒ(X,\vec{x}₀), ρ₀=\vec{r}₀^{T}\vec{r}₀
computing the following expression using secure computation, and generating a secret value of a vector a\vec{ }ᵢ₋₁;
\vec{a}ᵢ₋₁=D×(ƒ(X,\vec{p}ᵢ₋₁))
computing the following expression using secure computation, and generating a secret value of a value γᵢ₋₁;
γᵢ₋₁=D×(\vec{p}ᵢ^{T}\vec{a}ᵢ₋₁)
computing the following expression using secure computation, and generating a secret value of a value αᵢ₋₁;
$${α}_{i - 1} = \frac{{ρ}_{i - 1}}{{γ}_{i - 1}}$$
computing the following expression using secure computation, and generating a secret value of a vector d\vec{ }ᵢ;
\vec{d}ᵢ=D×(αᵢ₋₁\vec{p}ᵢ₋₁)
computing the following expression using secure computation, and generating a secret value of a vector x\vec{ }ᵢ;
\vec{x}ᵢ=\vec{x}ᵢ₋₁+\vec{d}ᵢ
computing the following expression using secure computation, and generating a secret value of a vector r\vec{ }ᵢ;
\vec{r}ᵢ=\vec{r}ᵢ₋₁−αᵢ₋₁\vec{a}ᵢ₋₁
computing the following expression using secure computation, and generating a secret value of a value ρᵢ;
ρᵢ=D×(\vec{r}ᵢ^{T}\vec{r}ᵢ)
computing the following expression using secure computation, and generating a secret value of a value βᵢ;
$${β}_{i} = \frac{{ρ}_{i}}{{ρ}_{i - 1}}$$
computing the following expression using secure computation, and generating a secret value of a vector p\vec{ }ᵢ.
\vec{p}ᵢ=\vec{r}ᵢ−βᵢ\vec{p}ᵢ₋₁

5. A conjugate gradient method computation method executed by a conjugate gradient method computation apparatus configured to obtain, letting X be a set of values for computing a product of a d-dimensional real symmetric positive definite matrix A and a d-dimensional vector, b\vec{ } be a d-dimensional vector, f be a function for computing Ax\vec{ } based on a matrix X and a d-dimensional vector x\vec{ }, k be an integer of d or less, i be each of integers from 1 to k, x\vec{ }₀ be a d-dimensional vector for which a suitable value is set, and D be a value whose absolute value is less than 1 and other than 0, an approximate solution x\vec{ }ₖ of a solution x\vec{ }* of Ax\vec{ }=b\vec{ } with the set X and the vector b\vec{ } used as inputs,
the conjugate gradient method computation method comprising:
computing the following expression, and generating vectors p\vec{ }₀ and r\vec{ }₀ and a value ρ₀;
\vec{p}₀=\vec{r}₀=\vec{b}−ƒ(X,\vec{x}₀), ρ₀=\vec{r}₀^{T}\vec{r}₀
computing the following expression, and generating a vector a\vec{ }ᵢ₋₁;
\vec{a}ᵢ₋₁=D×(ƒ(X,\vec{p}ᵢ₋₁))
computing the following expression, and generating a value γᵢ₋₁;
γᵢ₋₁=D×(\vec{p}ᵢ^{T}\vec{a}ᵢ₋₁)
computing the following expression, and generating a value αᵢ₋₁;
$${α}_{i - 1} = \frac{{ρ}_{i - 1}}{{γ}_{i - 1}}$$
computing the following expression, and generating a vector d\vec{ }ᵢ;
\vec{d}ᵢ=D×(αᵢ₋₁\vec{p}ᵢ₋₁)
computing the following expression, and generating a vector x\vec{ }ᵢ;
\vec{x}ᵢ=\vec{x}ᵢ₋₁+\vec{d}ᵢ
computing the following expression, and generating a vector r\vec{ }ᵢ;
\vec{r}ᵢ=\vec{r}ᵢ₋₁−αᵢ₋₁\vec{a}ᵢ₋₁
computing the following expression, and generating a value ρᵢ;
ρᵢ=D×(\vec{r}ᵢ^{T}\vec{r}ᵢ)
computing the following expression, and generating a value βᵢ;
$${β}_{i} = \frac{{ρ}_{i}}{{ρ}_{i - 1}}$$
computing the following expression, and generating a vector p\vec{ }ᵢ.
\vec{p}ᵢ=\vec{r}ᵢ−βᵢ\vec{p}ᵢ₋₁

6. A non-transitory computer-readable recording medium on which a program is recorded for causing a computer to perform the method of claim 4.

7. A non-transitory computer-readable recording medium on which a program is recorded for causing a computer to perform the method of claim 5.
